(19) United States
(12) Patent Application Publication
(10) Pub. No.: US 2008/0306727 A1
(43) Pub. Date: Dec. 11, 2008

(54) Hybrid Machine Translation System

(75) Inventors: Gregor Thurmair, Muenchen (DE); Thilo Will, Freising (DE); Vera Aleksic, Muenchen (DE)

Correspondence Address: WOLF GREENFIELD & SACKS, P.C., 600 ATLANTIC AVENUE, BOSTON, MA, 02210-2206, US

(73) Assignee: LINGUATEC SPRACHTECHNOLOGIEN GMBH, MUENCHEN (DE)

(21) Appl. No.: 11/885,688

(22) PCT Filed: Mar. 7, 2005
(86) PCT No.: PCT/EP2005/002376

§ 371 Date: May 13, 2008

(51) Int. Cl. G06F 17/21; G06F 17/28

(52) U.S. Cl. 704/4; 704/10

(57) ABSTRACT

In order to achieve improvement of the accuracy and speed of a conversion of source language elements to target language elements a machine translation system is provided with context and linguistic processing comprising a dictionary storage 100, linguistic analysis storage 114, transfer rule storage 116 and a context storage 130, wherein selecting means 118 determines an order of selection among transfer rules to be executed to obtain target language elements from linguistic processing and target language elements from context processing. The correlation between language elements and context elements is obtained using a neural network.

### FIELD OF THE INVENTION

The present invention relates to a hybrid machine translation system, and in particular to a hybrid machine translation system for converting source text consisting of source language elements to a target text consisting of target language elements using syntax and semantics of said source language and elements of said source text.

### TECHNOLOGICAL BACKGROUND

In the past years the use of machine translation systems has become increasingly popular due to the more and more sophisticated systems on the market. Understanding language without having to learn it has been ever since a dream of humanity. Machine translation systems enable the conversion of a source text of a source language into a target text of a target language by using electronically encoded dictionaries.

Current electronic dictionaries, however, are typically derived from printed dictionaries and display information in the same format. Since current printed dictionaries include multiple target language element entries for one source element entry, it is left to a human user to select the correct target language element using his knowledge of the syntax and semantics of the source language text as well as of the target language text. Therefore, for a translation with a current electronic dictionary, the user still has to interfere in the process of translation to obtain a meaningful result by determining, which of displayed information is relevant, if a language element, such as a word, has more than one syntactic category or is otherwise ambiguous. Therefore, the only advantage of using the electronic dictionary is that the lookup is faster than the lookup in the printed dictionary.

FIG. 1 shows a further development of a machine translation system including the use of selection rules associated with a source language element entry in a dictionary database. The dictionary database 10 can include an indication of the selection rule, for example indices or pointers to a storage location 30, . . . , 38, where the selection rule is stored. These selection rules control the selection of the target language element, namely the translation, for a given source language element, such as a word, a character or a number.

Since there are for each source language element multiple selection rules corresponding to different possibilities for target language elements, an ordering strategy has to be defined to define a sequence, in which the selection rules are executed. This strategy can be based on heuristics or on a numbering strategy of the selection rules within the dictionary database. FIG. 1 shows selecting means 20 for selecting a selection rule and subsequently executing the selection rules from the top to the bottom.

In detail, said selecting means 20 selects a selection rule, which is then loaded and applied to an input string of source language elements. If a condition of the selection rule is fulfilled, a respective storage 40, . . . , 48, in which the target language element corresponding to the selection rule is stored, is accessed. However, if the condition of the selection rule is not fulfilled, the next selection rule is executed.

Different selection rules can be applied subsequently to the same string of source language elements. These selection rules can perform tests such as searching for a specific compound of elements, wherein the compound comprises a source language element to be converted into a target language element.

For example, said test could determine, whether a specific language element, such as “climbing”, is placed in front of a specific source language element, for example “plant”. If this test fails, another test belonging to a different selection rule might determine whether a specific language element, such as “alcohol”, is placed in front of said source language element. In case the condition of the test would be satisfied, i.e. said string contains “alcohol plant” in this example, a possible translation stored in advance into a target language, such as German, would result in “Brennerei” and not in “Alkoholpflanze”, since the target language element stored for the specific selection rule associated with “alcohol” and “plant” would be defined as “Brennerei”. As described above, the sequence of the selection rules with their associated tests is determined in advance and there might be a case, in which several selection rules have to be applied until a match is obtained or a case that no match at all is obtained.

Another example for converting a source language element into a target language element without using a dictionary database, similar to the one described above, and an ordering strategy with selection rules, might be a purely statistical approach using statistical considerations to obtain a target language element.

In all the above described systems, the performance and quality of a translation output is of vital interest and a problem still exists in the ambiguous nature of several source language elements corresponding to a plurality of possible target language elements, such as the language element “plant” and the selection rules might not account for all variations in a language.

Further, selection rules have to be set up manually, which is very time consuming, since human knowledge is involved by creating tests relevant for specific language elements. Basically a developer has to think about all different variations, in which the language element “plant” may occur in any context. Thinking of all possibilities seems to be an enormous unsolvable issue.

Still further, a huge storage would be required to store all possible tests with respect to the language element entries in a dictionary.

Still further, substantial processing power is necessary to process multiple selection rules and their associated tests with respect to a huge amount of input source language elements in a source text, which slows down the system tremendously.

Therefore, there is a need for a system overcoming the problems of the prior art by taking into account the considerations discussed above.

### SUMMARY OF THE INVENTION

It is therefore an object of the present invention to provide a machine translation system to improve the accuracy and speed of a conversion of source language elements to target language elements.

This object of the present invention is solved by a machine translation system for converting a source text consisting of source language elements to a target text consisting of target language elements using syntax and semantics of said source language elements of said source text comprising:

an input storage containing said source text of source language elements;

a dictionary storage storing target language elements and language elements associated with predetermined language element types, predetermined transfer rules and target language elements, wherein each transfer rule corresponds to one target language element;

a linguistic processing unit for determining at least one language element type of source language elements of a string of source language elements of said source text by searching said dictionary storage for a language element corresponding to said source language element and determining a linguistic structure of said source language elements of said string based on the determined language element types using a predetermined syntax algorithm;

a linguistic analysis storage for storing said linguistic structure determined for said string of source language elements;

a transfer rule storage storing said predetermined transfer rules;

selecting means for selecting at least one specific transfer rule to be used with respect to a specific source language element;

executing means for applying a selected transfer rule to said linguistic structure;

converting means for converting a source language element into a target language element by searching a language element stored in the dictionary storage corresponding to said source language element and by using a result of the application of said selected transfer rule by said executing means;

a context storage for storing language elements and target language elements, wherein each language element corresponds to at least one context element predetermined in advance and said context element corresponds to one target language element, the context element comprising of at least one predetermined language element substantiating said target language element;

a contextual processing unit for determining source language elements of said string which are used as context elements;

a contextual text storage for storing said context elements corresponding to said source language elements; context executing means for accessing said context storage and determining a language element of said context storage which matches a source language element of said string and which is associated with a context element stored in said context storage matching a context element of said string stored in said contextual text storage;

wherein said selecting means is further adapted to select for a source language element from said context storage a unique target language element corresponding to a context element and language element based on the determination by said context executing means; and

wherein said selection means is further adapted to determine an order of selection among transfer rules to be executed to obtain target language elements and said target language elements stored in the context storage based on weighting functions associated with the transfer rules and said target language elements stored in the context storage.

Therefore, the speed and accuracy of a translation output is improved tremendously, since the ambiguity with respect to multiple target language elements for one source language element can be resolved and a combination of transfer rules and contextual processing complement each other.

Further, the use of said context storage 130 is less computation intensive basically involving a match-up check in said context storage 130, in comparison to the use of transfer rules. Therefore, the problem of processing power is solved speeding up the system. Also the linguistic processing may be skipped, further reducing the computation requirements.

Still further, a combination of using contextual and linguistic processes reduces the requirements for memory while obtaining better results by selecting the process according to predetermined weighting functions.

According to an embodiment said dictionary storage is further adapted to store weights corresponding to transfer rules. Accordingly, the performance of the weighting functions is improved further increasing speed and accuracy.

According to an embodiment said context storage is further adapted to store weights corresponding to said target language elements. Accordingly, the performance of the weighting functions is improved further increasing speed and accuracy.

According to an embodiment said weighting functions weight said transfer rules more than said target language elements stored in said context storage. Therefore, the target language elements relating to transfer rules are preferably selected.

According to another embodiment said weighting functions weight said transfer rules less than said target language elements stored in said context storage. Therefore, the target language elements stored in said context storage are preferably selected.

According to another embodiment said weighting functions weight transfer rules relating to compound language elements highest, said target language elements stored in said context storage second to highest, transfer rules relating to specific subject matters of source texts second to lowest and defaults not associated with a transfer rule lowest.

According to another embodiment said weighting functions weight transfer rules relating to compound language elements highest and target language elements stored in said context storage with large weights second to highest. Accordingly, transfer functions relating to compound language elements are preferred.

According to another embodiment said order of selection among said execution of transfer rules to obtain target language elements and said target language elements stored in said context storage (130) is based on predetermined or dynamic weighting functions. Therefore, weighting functions can be changed during translation to adapt to the environment.

According to another embodiment said dynamic weighting functions are determined by a neural network according to at least one of the following the size of said dictionary storage, the size of said context storage and the source text. Accordingly, weighting functions can be changed during translation by obtaining information about the source text in the process of translation and the neural network is trained constantly in the process.

According to another embodiment a context element comprises of at least one predetermined language element obtained by a neural network and wherein each target language element is weighted according to the context element. Accordingly, the information of the context storage is increased constantly by new context elements supplied by the neural network.

According to another embodiment said system further comprises a text corpus analysis means for obtaining a correlation between language elements and context elements using a neural network. Accordingly, the context storage is dynamically increased by supplying additional test corpuses to said text corpus analysis means.

According to another embodiment an output unit for outputting said selected target language elements is provided, wherein said output unit is adapted to analyze a structure of a string of target language elements according to language element types of the target language elements. Accordingly, the reliability of a translation result can be checked improving the accuracy of the translation.

According to another embodiment said source language elements stored in said dictionary storage further comprise indices indicating an entry in the context storage. Accordingly, the selecting means only needs to access the dictionary storage to select a target language element.

According to another embodiment said input storage is adapted to store said source text of source language elements in form of speech or written text. Accordingly, a translation system is obtained translating speech. Further, said system comprises a speech-to-text unit for converting speech into text.

According to another embodiment said language element types stored in said dictionary storage comprise at least one of a noun, verb, adjective, adverb.

According to another embodiment said determined linguistic structure is a syntax tree structure represented by directed acyclic graphs. Therefore, the source language elements are structured and connected so that an analysis with a syntax algorithm can be performed easily.

According to another embodiment said syntax algorithm includes information about a position of said language element types in a string of source language elements. Accordingly, the language element type of a source language element with more than two language element types can be determined.

According to another embodiment said transfer rules stored in said transfer rule storage comprise a test for a source language element to check whether a specific condition is satisfied in said linguistic structure. Therefore, the ambiguity of a source language element can be reduced.

The object of the present invention is further solved by machine translation method for converting a source text consisting of source language elements stored in an input storage to a target text consisting of target language elements using syntax and semantics of said source language elements of said source text comprising the steps of:

a) storing in a dictionary storage target language elements and language elements associated with predetermined language element types, predetermined transfer rules and target language elements, wherein each transfer rule corresponds to one target language element;

b) determining at least one language element type of source language elements of a string of source language elements of said source text by searching said dictionary storage for a language element corresponding to said source language element and determining a linguistic structure of said source language elements of said string based on the determined language element types using a predetermined syntax algorithm;

c) storing said linguistic structure determined for said string of source language elements in a linguistic analysis storage;

d) storing said predetermined transfer rules in a transfer rule storage;

e) selecting at least one specific transfer rule to be used with respect to a specific source language element;

f) applying a selected transfer rule to said linguistic structure;

g) converting a source language element into a target language element by searching a language element stored in the dictionary storage corresponding to said source language element and by using a result of the application of said selected transfer rule;

h) storing language elements and target language elements in a context storage, wherein each language element corresponds to at least one context element predetermined in advance and said context element corresponds to one target language element, the context element comprising of at least one predetermined language element substantiating said target language element;

i) determining source language elements of said string which are used as context elements;

j) storing said context elements corresponding to said source language elements in a contextual text storage;

k) accessing said context storage and determining a language element of said context storage which matches a source language element of said string and which is associated with a context element stored in said context storage matching a context element of said string;

l) further selecting for a source language element from said context storage a unique target language element corresponding to a context element and language element based on the determination of step k); and

m) further determining an order of selection among transfer rules to be executed to obtain target language elements and said target language elements stored in the context storage based on weighting functions associated with the transfer rules and said target language elements stored in the context storage.

A computer program product directly loadable into the internal memory of a digital computer is provided, comprising software code portions for performing the above mentioned steps, when said product is run on a computer.

Further, a computer readable medium is provided, having a program recorded thereon, wherein the program is to make the computer execute the above-mentioned steps.

### BRIEF DESCRIPTION OF THE DRAWINGS

FIG. 1 illustrates a machine translation system according to the prior art;

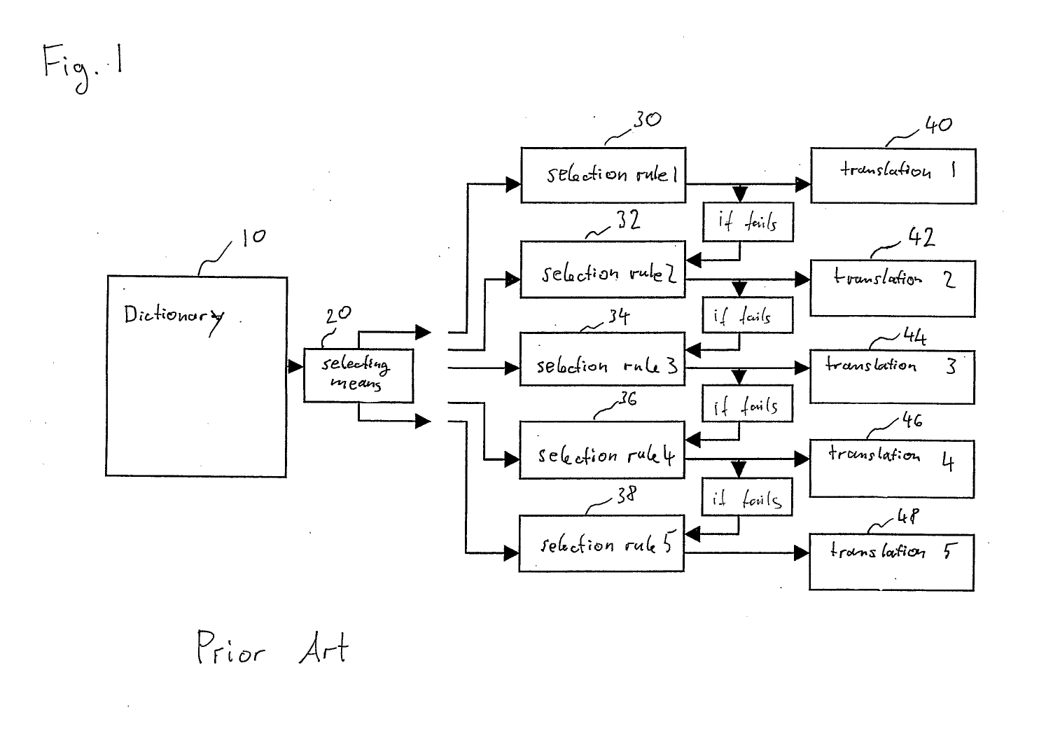

FIG. 2 illustrates a hybrid machine translation system according to an embodiment of the present invention;

FIG. 3 illustrates a syntax tree structure;

FIG. 4 illustrates a database structure of the dictionary storage according to an embodiment of the present invention;

FIG. 5 illustrates a database structure of the context storage according to an embodiment of the present invention;

FIG. 6 illustrates another embodiment of the present invention;

FIG. 7 illustrates an alternative embodiment of the present invention.

### DETAILED DESCRIPTION OF THE PREFERRED EMBODIMENTS

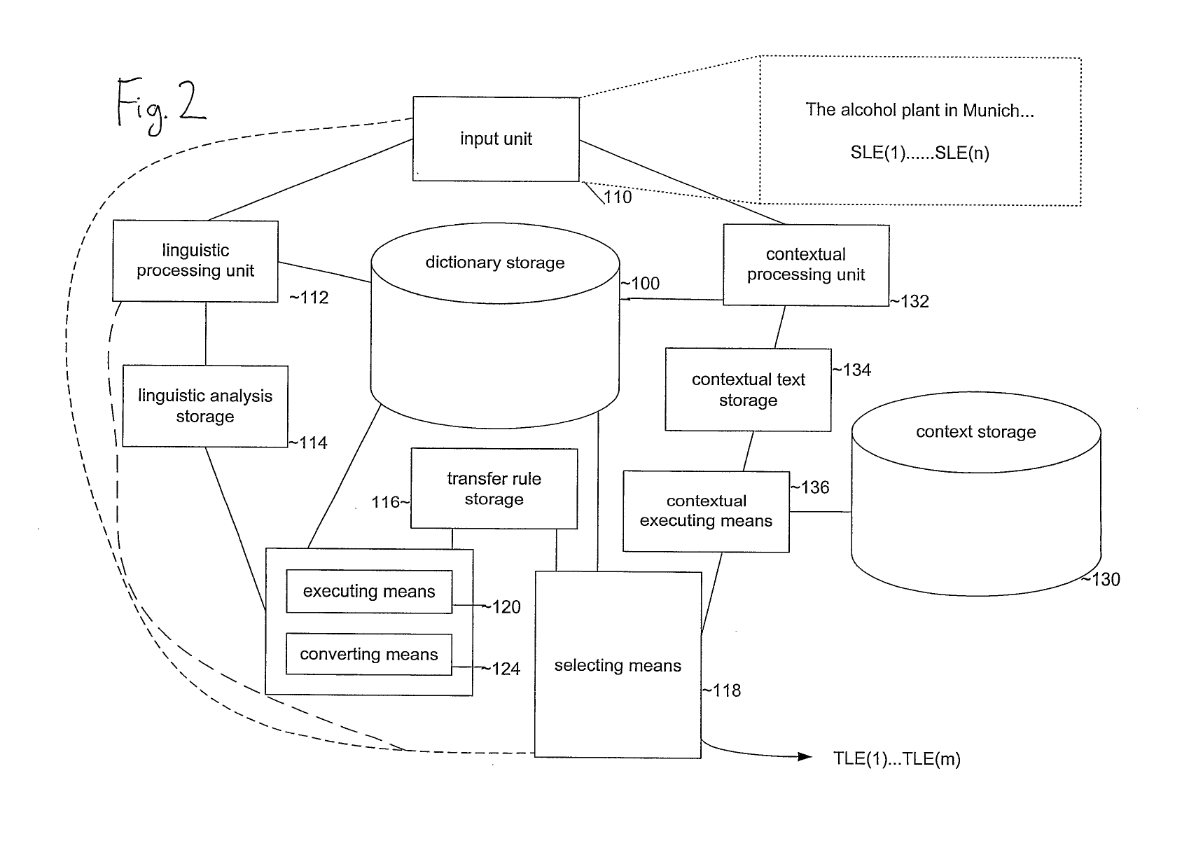

In the following a first embodiment of the present invention will be described with regard to FIG. 2.

FIG. 2 illustrates components of the machine translation system of the present invention for converting source text consisting of source language elements SLE(1), . . . , SLE(n) to a target text consisting of target language elements TLE(1), . . . , TLE(m) using syntax and semantics of said source language elements of said source text.

In particular, the machine translation system comprises an input unit 110, a dictionary storage 100, a linguistic processing unit 112, a linguistic analysis storage 114, a transfer rule storage 116, selecting means 118, executing means 120, converting means 124, a context storage 130, a contextual processing unit 132, a contextual text storage 134 and context executing means 136. In one example a controller (not shown) can be used to control the above-mentioned components.

The mentioned storages might be one or several of the following components, a RAM, a ROM or hard disc, an (E)EPROM, a disc or even a flash memory but are not limited to these components.

The linguistic processing unit 112, selecting means 118, executing means 120, converting means 124, contextual processing unit 132, context executing means 136, for example, may be realized by a microprocessor, computer or integrated circuit but are not limited thereto.

Said input unit 110 contains said source text of source language elements SLE(1), . . . , SLE(n). Preferably, the source language elements are words in a source language and are input in the input unit by an interface such as a keyboard or a disc or similar data inputting or carrying means. However, source language elements might also be characters or numbers, such as Chinese characters and Roman numbers.

According to one example the source text of source language elements SLE(1), . . . , SLE(n)is stored in said input unit including an input storage and said text comprises multiple strings of source language elements SLE(1), . . . , SLE(n). One after another or multiple strings may then be transferred to said linguistic processing unit 112 and said contextual processing unit 132. The transfer can be done serially or in parallel, wherein in the preferred parallel transfer said string is preferentially copied and a respective copy is sent to said linguistic processing unit 112 and said contextual processing unit 132. Examples for processing units comprise a microprocessor or a PC or laptop.

Said dictionary storage 100 stores target language elements TLE(1), . . . , TLE(m) and language elements LE(1), . . . , LE(n) associated with predetermined language element types LET(1), . . . , LET(n), predetermined transfer rules TR(1), . . . , TR(n) and target language elements, wherein each transfer rule corresponds to one target language element TLE.

Preferably, only said target language elements TLE(1), . . . , TLE(m) and language elements LE(1), . . . , LE(n) are stored in said dictionary storage and indices may be used to link a language element with a specific transfer rule, which can be stored differently as described below. These connections may also be realized by pointers or hardwiring.

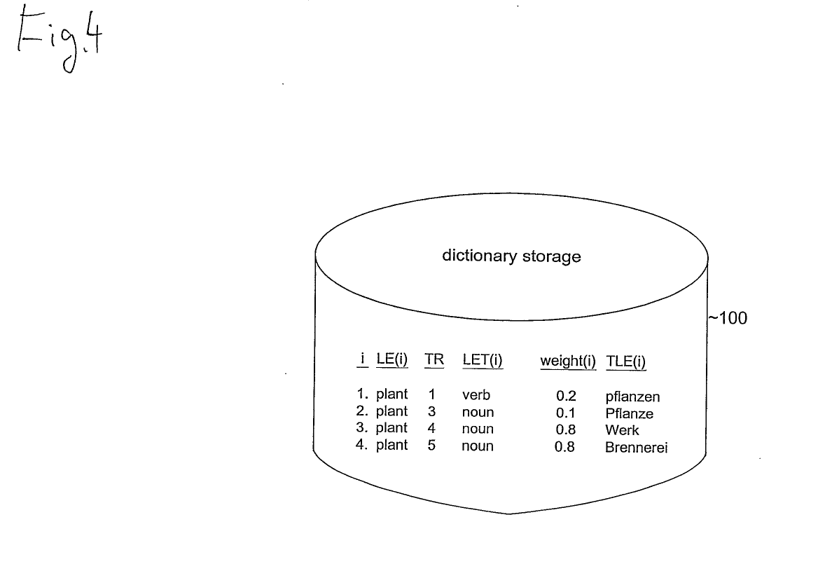

Further, the dictionary storage may be realized by a table or matrix of entries storing in the first column language elements and in subsequent columns language element types, transfer rules indices and target language elements. Each target language element is placed on the same line in the table as a specific transfer rule or transfer rule index for this target language element, a language element type and a language element Therefore, when determining a specific language element the language element types, transfer rules and target language elements can be correlated with each other by checking one specific line. The dictionary storage with its database structure will be described in detail below with reference to FIG. 4 including the language element types, such as verb, noun, adjective, etc.

Said linguistic processing unit 112 determines at least one language element type LET of source language elements SLE(1), . . . , SLE(n) of a string of source language elements of said source text by searching said dictionary storage 100 for a language element LE corresponding to said source language element SLE and determining a linguistic structure of said source language elements of said string based on the determined language element types using a predetermined syntax algorithm.

The operation of the linguistic processing unit may for example be described as follows. The linguistic processing unit receives a string of source language elements from the input unit. This string might be received, for example, as ASCII text. Subsequently, the string is analyzed. Therefore, the linguistic processing unit 112 is connected to said dictionary storage 100 to access said dictionary storage and to search for at least one source language element of said string a corresponding language element that matches with said at least one source language element of said string. As described above, when a language element matches with a source language element, at least one possibility for a language element type corresponding to said source language element may be found.

Using the information about the language element type coupled to said language element and, thus, to said source language element, the complete string of source language elements can be analyzed by using a linguistic structure described in the following.

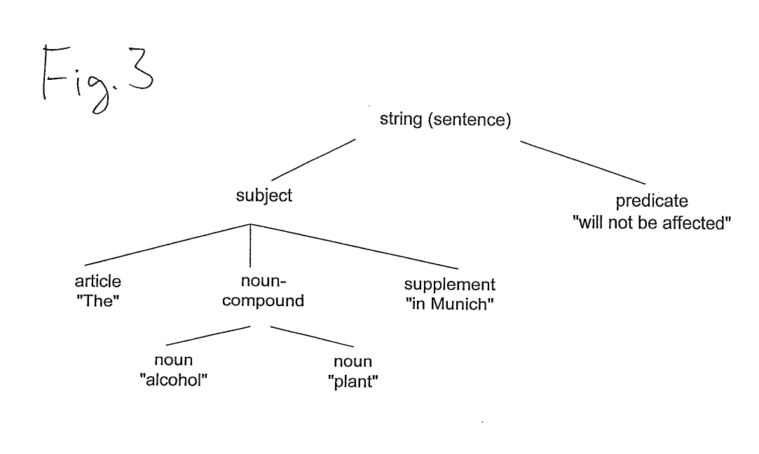

Referring back to the example using the language element “plant”, this language element might be associated with a language element type “verb” or “noun” as indicated in FIG. 4, which is not unambiguous. However, this ambiguity might be overcome as illustrated in FIG. 3.

FIG. 3 shows an example of a linguistic structure, in which the string “The alcohol plant in Munich will not be affected” is analyzed. Such a linguistic structure may be for example a syntax tree structure and determined by the linguistic processing unit. Thereby, said linguistic processing unit 112 of FIG. 2 obtains for each source language element of said string at least one corresponding language element type as described above and uses a predetermined syntax algorithm providing several feasible syntax structures for said string in said source language, namely several possible positions in said string for article, noun, verb, etc. Thus, the ambiguity is resolved and it becomes clear from the example that “plant” cannot be a verb but must be a noun.

The linguistic processing unit 112 transmits said linguistic structure containing information about said source language elements of said string with their associated language element types as well as their position in said linguistic structure.

Said linguistic analysis storage 114 stores said linguistic structure determined for said string of source language elements.

Preferably, said linguistic structure containing said string is divided in different levels corresponding to different sub storages in said linguistic analysis storage, top level being said string, followed by a middle level defining subject and predicate, a lower lever defining for example article, noun-compound and supplement and a sub layer defining nouns of a noun-compound. All the different sub storages might be connected by wire or by pointers or indices so that complex structure is created which is shown as tree structure merely for illustrative purposes.

Said transfer rule storage 116 stores said predetermined transfer rules mentioned above with respect to the dictionary storage 100.

Preferably, a transfer rule comprises a test for a source language element to check whether a specific condition is satisfied in connection with said source language element. Examples for transfer rules and their tests are described below.

Further in FIG. 2, said selecting means 118 selects at least one specific transfer rule to be used with respect to a specific source language element.

Preferably, a string of source language elements to be translated is transferred to said selecting means from said input unit 110. However, it is also feasible that said selecting means obtains said string from said linguistic processing unit 112 as well as from said linguistic analysis storage 114 or executing means 120 together with linguistic structure information, such as language element types of said source language elements. Preferred possibilities are indicated in FIG. 2 by dashed lines.

Said selecting means 118 then selects, according to the source language elements in said string, by accessing said directory storage, a transfer rule corresponding to a language element matching a specific source language element in said string and preferably also according to the language element type of said source language element.

Furthermore, for example, in the case that the linguistic processing unit 112 determines that there are no ambiguities between several source language elements of said string and language elements in the dictionary storage, meaning that each of said several source language elements corresponds exactly to one target language element, than a transfer rule can be selected, which directly takes said target language element, without having to execute a test associated with a transfer rule.

Further, said executing means 120 applies said transfer rule selected by said selecting means 118 to said linguistic structure, wherein an example for an executing means might be a microprocessor.

In one example, said executing means 120 obtains said linguistic structure including said source language elements of said string from said linguistic analysis storage 114 and applies said transfer rule, which is selected by said selecting means and fetched from said transfer rule storage 116.

Now it is referred back to said linguistic structure shown in FIG. 3, on which transfer rules can be applied. As described above, the syntax tree structure contains a string of source language elements constituting, for example, one or more sentences, which is then divided into parts of said string, such as subject and predicate by using a syntax algorithm.

This syntax algorithm includes information about the possible positions of language element types of source language elements, wherein the language element types, such as article, noun and verb, correspond to language elements as defined in the dictionary storage.

In detail, the subject of said string may be further subdivided into language element types and the source language elements with their language element types can be analyzed using the syntax tree structure. For example, the language element “plant” could be a verb or a noun, however, in the syntax tree structure above only the language element type noun is possible. Therefore, it is determined that only transfer rules relating to tests, in which the source language element is a noun, have to be used in the further process.

Different transfer rules may be applied subsequently to the same string of source language elements included in said linguistic or syntax tree structure. These transfer rules perform tests, such as searching for an adjective-compound (e.g. adjective-noun) comprising the source language element to be converted.

In this example, said test relating to said source language element “plant” may determine whether an adjective, such as “climbing”, is placed in front of said source language element “plant”. If this test fails, another test belonging to a different selection rule might determine, whether a noun, such as “alcohol” is placed in front of said source language element. Then, the condition of the test would be satisfied in this example and a possible translation into a target language, such as German, would result in the target language element “Brennerei”.

Subsequently, said converting means 124 converts a source language element into a target language element by searching a language element stored in the dictionary storage 100 corresponding to said source language element SLE and by using a result of the application of the specific selected transfer rule executed by said executing means 120.

In detail, after said executing means has applied a specific transfer rule, said executing means provides information about the source language element and the corresponding transfer rule to the converting means 124 connected with said executing means. This searches for the language element matching said source language element and the associated applied transfer rule in the dictionary storage 100 and looks up the corresponding entry for said combination of language element and transfer rule and fetches the corresponding entry for the translation, namely in this example the corresponding target language element placed on the same line of said dictionary table as shown in FIG. 4.

Optionally, it is also feasible that the converting means obtains said information about the source language element and the corresponding transfer rule applied by said executing means 124 from said selecting means, since the selecting means instructs the executing means and thus has the same information.

Preferably, only the source language element corresponding to a transfer rule that was successfully applied by said executing means is converted. This is, this source language element is converted, for which a test of said transfer rule satisfies a specific condition, such as in the example above the transfer rule regarding “alcohol”, since the dictionary storage 100 has an entry for the combined occurrence of “alcohol” and “plant” leading to “Brennerei”, which is then chosen as a target language element. This target language element can then be passed to the selecting means, directly to an output unit or to an intermediate storage, which can be accessed, e.g. by the selecting means, if it is decided that this target language element is to be chosen to be output as a result of the machine translation.

The previous description referred to an example to achieve a translation with a linguistic based process and is shown in the left arm of FIG. 2.

Further, translations may be generated in the right arm of FIG. 2, these translations may be generated independently or in combination with the above described left arm.

The contextual processing of the machine translation system in the right arm will be described in the following with respect to FIG. 2.

Starting with the above-described input unit 110 containing said source text of source language elements SLE(1), . . . , SLE(n). From this unit, strings of source language elements may be transferred to said contextual processing unit 132, wherein a string might be one or more sentences of words or characters.

Further, next to said contextual processing unit 132 described below, the right arm of FIG. 2 comprises said context storage 130 storing language elements LE(1), . . . , LE(x) and target language elements TLE(1), . . . , TLE(y), wherein each language element LE corresponds to at least one context element CE predetermined in advance and said context element corresponds to one target language element TLE, the context element comprising of at least one predetermined language element LE substantiating said target language element TLE.

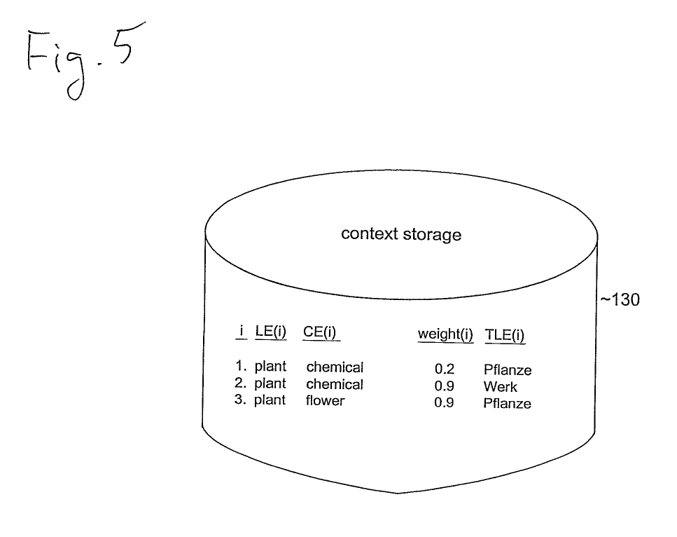

Preferably, the context storage described in detail below with reference to FIG. 5 is constructed similarly to the dictionary storage 100 comprising for example a look-up table or matrix with columns such as language element, context element, weight and target language element. Each target language element is placed on the same line in the matrix as a corresponding language element and context element. Therefore, when it is desired to determine a specific target language element for a source language element, it is possible that there are several target language elements corresponding to the same language element.

However, using further the context information contained in said string of source language elements, which contains said source language element, it is possible to further define or substantiate a specific target language element. Therefore, the context storage comprises a further column for the weights of the target language element.

In the example described below, it will become clear that “Werk” (Engl. “plant” in the meaning of factory), if the source text comprises, e.g. the source language element “chemical”, has a much higher probability to be true than the target language element “Pflanze” (Engl. “plant” in the meaning of vegetable/tree/flower). Therefore, the weight is adjusted in the context storage accordingly.

It should be noted, that said weights are only a further embodiment of the present invention, since the basic concept also is applicable with weights of 0 and 1, namely the entry in the context storage is present or not. The creation of the context storage, which is fed by a neural network, is described in detail below.

FIG. 2 further shows said contextual processing unit 132 for determining source language elements of said string, which are used as context elements.

Preferably, this unit is connected to said input unit 110 to receive source text containing source language elements in strings. These source language elements obtained by said contextual processing unit may be grouped by said unit or filtered. For example, each source language element is grouped according to its position in the string.

Another example would be that the contextual processing unit only selects source language element, which are unambiguous by cross checking with the entries of said dictionary storage 100, thereby the context in which these source language elements appear might be largely defined. For example, the meaning of “chemical” is unambiguous defining the context in which this word occurs clearly, namely chemistry, industry, biotechnology, etc. Therefore, “chemical” would be a good candidate for a context element.

Another example for filtering might be to delete source language elements constituting filler words, such as “in, a, the, of”, which do not increase the contextual understanding of a text.

In the example “Novartis closed their chemical subdivision in Germany. The plant in Munich will not be affected.” The result of the contextual processing unit might give the entries shown in Table 1.

TABLE 1

| | | |
|---|---|---|
| Novartis | close | chemical |
| subdivision | Germany | Munich |
| plant | affect | |

Preferably, the result of said contextual processing unit is then forwarded to be stored in said contextual text storage 134.

Said contextual text storage 134 stores said context elements corresponding to said source language elements.

The storage entries may look like in the example of Table 1 above. In this example, filler words, which do not add further information with respect to the context of the source text have been omitted. The storage entries are then provided for further analysis by the contextual executing means.

Said context executing means 136 of FIG. 2 accesses said context storage 130 and determines a language element LE of said context storage 130 which matches a source language element SLE of said string and which is associated with a context element stored in said context storage matching a context element of said string stored in said contextual text storage.

In other words, said context executing means 136 determines a language element LE of said context storage 130 matching a source language element SLE of said string and at the same time determines a context element CE associate with said language element and stored-in said context storage matching a context element of said string stored in said contextual text storage.

Therefore, if a source language element matches a language element and a context element in the same string (e.g. two sentences) as said source language element matches a context element in said context storage linked to said language element, a unique target language element is obtained. Clearly, there is a high probability that the corresponding target language element, namely the target language element linked to said context element and language element, is a good translation for said source language element. Preferably, this probability is indicated in said context storage by assigning a weight to said target language element.

The context executing means 136 is connected to said context storage as seen in FIG. 2 and further to said contextual processing unit 132 as well as to said selecting means.

To trigger the context executing means to access said context storage and said contextual text storage, the context executing means may receive a signal from the selecting means or may receive directly a source language element to be converted to a target language element.

However, it may be preferable to access the context storage 130 from context executing means 136, when there is source text to be converted in said contextual text storage.

Said selecting means 118 is further adapted to select for a source language element SLE from said context storage a unique target language element TLE corresponding to a context element and language element based on the determination by said context executing means 136.

This selection may be performed directly by accessing said context storage or through said context executing means after said context executing means determined that said target language element is present in said context storage, which is linked to a context element corresponding to a context element in said contextual text storage.

The result of the analysis of the context executing means, whether there are good matches in the context storage or not, may also be stored in an intermediate storage (not shown) from which said selecting means may select target language element candidates. Instead of the intermediate storage, these target language elements with their weight and context information may also be stored in said dictionary storage.

Further, said selection means 118 is adapted to determine an order of selection among the transfer rules to be executed to obtain target language elements and said target language elements stored in the context storage 130 based on weighting functions associated with said transfer rules and said target language elements stored in the context storage.

In other words, said selection means 118 is adapted to determine a sequence indicating whether one or more transfer rules are executed to obtain target language elements before target language elements from said context analysis are selected. This sequence is defined by weighting functions associated with the transfer rules and said target language elements stored in said context storage or intermediate storage (not shown).

For example, these weighting functions controlling said sequence may be calculated using weights defined for each target element in said dictionary storage and context storage as shown in FIGS. 4 and 5. Further, the weighting functions may be determined by taking into account the subject matter of said source text.

Referring back to the example shown in Table 1, in this case the result for a transfer rule analysis would still be ambiguous, since “plant” is not part of a noun-compound or analyzable by another transfer rule.

Here, the context executing means may help. As explained above, said string contains “chemical” which is defined as a context element with a high probability for “werk”. Therefore, the contextual processing of the right arm of the system resolves the ambiguity of the word “plant” by using a, so called, “neuro-“werk”-cluster” associated with the entries in Table 1, basically performing the look up in the context storage and contextual text storage. In this example, using said “neuro-“werk”-cluster” on the context storage leads to the specific target language element “werk”, since there is a match-up for the context element “chemical”.

Therefore, the speed and accuracy of a translation output is improved tremendously, since the ambiguity with respect to multiple target language elements for one source language element can be resolved. It is obvious that using a combination of transfer rules and contextual processing complement each other, which is achieved by providing a selection from multiple possibilities to achieve the best unambiguous target language element.

Further, the use of said context storage 130 is less computation intensive basically involving a match-up check in said context storage 130, in comparison to the use of transfer rules, which have to be looked-up and executed.

Therefore, the problem of processing power is solved speeding up the system. Also the linguistic processing may be skipped, further reducing the computation requirements.

Still further, a huge memory would be required to store all possible tests with respect to the language element entries in a dictionary storage, if unambiguous results with only transfer rules should be obtained. A combination of using contextual and linguistic processes reduces the requirements for memory while obtaining better results.

Therefore, using a hybrid machine translation system by appropriately selecting linguistic and contextual processing leads to increased processing speed and a less stringent requirement on memory as well as improved accuracy of the conversion of a source language element into a target language element.

As explained, the hybrid machine translation system set-up shows two conceptually different entities on the left side and right side, which complete each other and different variations of combining or separating the two readily becomes obvious to the person skilled in the art.

Now the dictionary storage is described in more detail. FIG. 4 shows an example of the dictionary storage structure 100. Preferably, the dictionary storage may contain six columns, referring to an indices, language elements, transfer rules linked to the respective language elements on the same line, language element types, weights and target language elements.

All entries on the same line are linked together, so that a specific transfer rule is connected to a respective language element, language element type, weight and target language element.

For example, if the language element “plant” is selected, because a source language element “plant” is contained in an input string inputted in the system, a specific transfer rule relating to the language element “plant” is selected by the selecting means leading to a target language element and an associated weight. Using the example above, the transfer rule 5 may relate to the noun-compound test for “alcohol” and the corresponding weight for this transfer rule.

FIG. 5 shows an example of said context storage 130. In this example, the context storage structure comprises of five columns, referring to a column for indices, language elements, context elements, weights and target language elements. All entries in the same line are linked to each other similarly to the description of FIG. 4.

As can be seen in FIG. 5, there are two possibilities for the combination of a language element “plant” and a context element “chemical”, namely “Planze” and “Werk”. However, the weighting factor clearly shows the differences in probability, indicating that the correct translation for “plant” combined with the context element “chemical” is “Werk”. Therefore, by looking up the matching language element for a source language element in an input string and further matching a context element of said string stored in said contextual text storage 134 with a context element in the context storage linked to said language element, a high probability for the correct translation can be achieved.

As indicated above, the weights in this example can be chosen to be zero and one so that there would merely be one entry for a target language element referring to the combination of “plant” and “chemical”.

One example of a modification of the system may be readily taken from Table 2 below showing the integration of sail context storage 130 in said dictionary storage 100.

TABLE 2

| No. (i) | LE(i) | Weight | Transfer Rule | TLE(i) |
|---|---|---|---|---|
| 1 | plant | 10 | Adjective-compound with | Kletter- |
| | | | “climbing” (“climbing | planze |
| | | | plant”) | |
| 2 | plant | 17 | Noun-compound with “power” | Kraftwerk |
| | | | (“power plant”) | |
| 3 | plant | 18 | Noun-compound with | Brennerei |
| | | | “alcohol” (“alcohol | |
| | | | plant”) | |
| 4 | plant | 18 | Subject Feed-Back-Control | Regelstrecke |
| 5 | plant | 30 | (default) | Werk |
| 6 | plant | 31 | (default) | Pflanze |
| 7 | plant | 32 | Neuro-“Werk”-Cluster | Werk |
| 8 | plant | 33 | Neuro-“Pflanze”-Cluster | Pflanze |

In Table 2 the context storage 130 and the dictionary storage are merged. In the first column, an index is provided for the entries. The second column shows a language element and an associated weight in the third column. Said language elements with their assigned weights, are linked to transfer rules shown in the fourth column. As described above, the transfer rules, for example, may be tests searching for an adjective-compound or a noun-compound in said specific string to be analyzed. In the last column, the target language element corresponding to the transfer rule is shown.

It has to be noted that in this table neuro-clusters from the contextual processing side are included, which are context elements and not real transfer rules but fulfill a similar function, a so called neural transfer, and are therefore shown for illustrative purposes.

In this example, the weight indicated in column 3 functions as a weighting function, determining which transfer rule or contextual processing is performed first.

In a further embodiment, already briefly mentioned above, the dictionary storage 100, as shown in FIG. 4, is further adapted to store weights corresponding to said transfer rules or target language elements, respectively. The usage of these weights allows to indicate preferred transfer rules for a specific language element or target language element.

Further, these weights may be used to determine an overall weighting function, taking also into account weights corresponding to target language elements stored in said context storage 130, constituting another preferred embodiment.

In one example, said weighting functions weight said transfer rules more than said target language elements stored in said context storage 130. This might be preferable in cases where the context storage is small and might not include a large amount of language elements and corresponding context elements so that the probability for a match in the context storage is low in the first place.

In another embodiment, said weighting functions weight said transfer rules less than said target language elements stored in context storage 130. This might be preferable, when the context storage is large so that a match with the context storage for a language element in the context element can be expected. Additionally, this might be preferable when the dictionary storage is small so that a result of an application of the transfer rule fulfilling test criteria is not expected.

In an alternative embodiment said weighting function weight transfer rules relating to compound language elements highest, said target language elements stored in said context storage second to highest, transfer rules relating to specific subject matters of source text second to lowest and defaults not associated with the transfer rule lowest. This is merely an example for setting up the weighting functions to obtain good results with the system. The exact configuration of the weighting functions used by said selecting means 118 has to be adapted to the requirement of the individual translation and the size of the different storages as well as speed of the processor(s) and the available total memory.

In a further embodiment, an order of selection among an execution of transfer rules to obtain target language elements and target language elements stored in said context storage, is based on predetermined or dynamic weighting functions. Predetermined weighting functions have been discussed above.

Dynamic weighting functions may be determined by a neural network, for example, according to the size of the dictionary storage or the size of the said context storage. As previously discussed, a large context storage improves the results of the contextual processing and, therefore, the weighting functions may be adjusted dynamically accordingly.

In the following example, it is shown how a neural network may be used to create the content for the context storage 130. For example, a context element comprises of at least one predetermined language element obtained by a neural network and each target language element is weighted according to said context element.

In detail, a neural-network may be trained so that it can be determined whether the word “plant” refers in a given context to “Pflanze” or “Werk”. Thereby, a huge text corpus is analyzed by a text corpus analysis means 200 for obtaining a correlation between language elements and context elements. This text corpus may include text as shown in Table 3.

TABLE 3

| | | |
|---|---|---|
| (1) | The Maharashtra Food and Drug | =>werk |
| | Administration (FDA) shut down the firm's | |
| | plant near Bombay after tablets manufactured | |
| | there were found to be contaminated. | |
| (2) | The Namibian Newspaper: DTA condemns | =>pflanze |
| | renewed talk of Epupa hydro plant. | |
| (3) | This page contains a picture of the new | =>Werk |
| | equalization tank at the wastewater treatment plant. | |

The third column of Table 3 is added by a developer and the translation is taken, for example, from the dictionary storage 100. From this, the content for the context storage is derived.

It is also feasible to use a hybrid machine translation system with a huge dictionary storage and transfer rule storage instead of a developer or other computing intensive statistical methods, since the creation of the context storage is not time sensitive and can be performed off-line, meaning when the context storage is created in the factory.

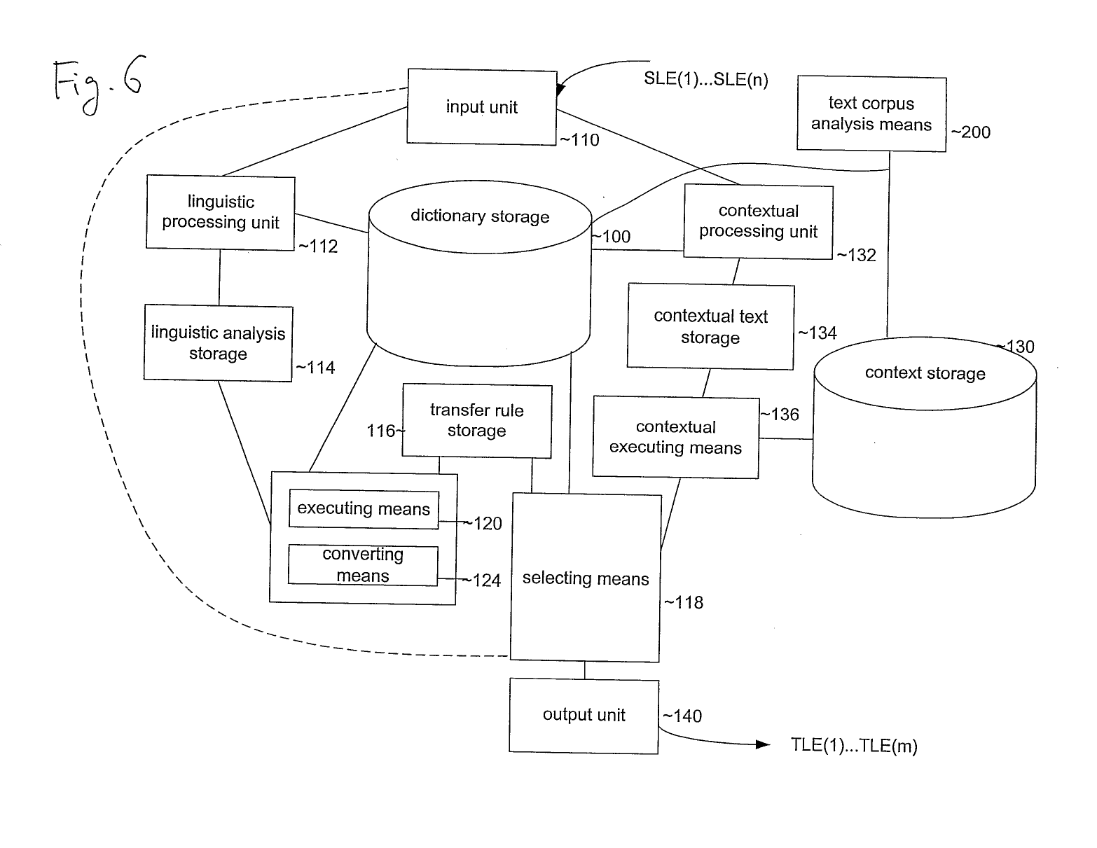

As shown in FIG. 6, the text corpus analysis means 200 is connected to the context storage and the dictionary storage, since the entries of the dictionary storage define all possible words in the source language and target language.

As shown in FIG. 6, an output unit for outputting said selected target elements may also be connected to the system. Said output unit may be one of the following: a display, a printer, a fax machine, a PDA, or only a data line for transferring the output data.

In a further embodiment, said output unit is adapted to analyze a structure of a string of target language elements according to language element types of the target language elements. For example, a similar setup as constituted by the linguistic processing unit 112, the linguistic analysis storage 114, and the dictionary storage 100, can be imagined. In this setup, the target language elements are the language elements in the dictionary storage and said mentioned predetermined syntax algorithm has to be adapted to the syntax of the target language.

In a further embodiment said source language elements stored in said dictionary storage 100 further comprise indices indicating an entry in the context storage. Pointers or similar means can perform this indication. Further, as described above, the entries in the context storage may also be directly stored in the dictionary storage.

In a further embodiment, said input unit is adapted to store said source text of source language elements in form of speech or written text. Thereby, speech or written text may be stored in data form, in a wave file format or an ASCII-format, respectively, but is not limited to these formats.

Additionally, said system may further comprise a speech-to-text unit for converting speech into written text, or preferably text in form of data, which can be processed by a computer.

In a further preferred embodiment said linguistic structure is a syntax tree structure represented by directed acyclic graphs.

An example for a tree structure might be similar to the structure of FIG. 3. FIG. 3 shows nodes such as a string, and subject and predicate, wherein subject can further be divided in article, noun-compound and supplement, and this tree structure uses information of a predetermined syntax algorithm such as described in T. Winograd “Language as a Cognitive Process”, vol. 1, Syntax. Addison-Wesley 1983.

The information obtained from such a syntax algorithm determining possible language structures, namely the position of article, noun, verb etc., may be compared to the language element types obtained for said source language elements of an input string. Thereby, in case of a word such as “plant”, which may have the meaning of a noun or a verb, using such a tree structure resolves such an ambiguity, since the tree structure would define a “plant” already as a noun in the linguistic tree structure. Therefore, preferably, said syntax algorithm includes information about a position of said language element types in a string of source language elements.

Examples for transfer rules stored in said transfer rule storage 116 are discussed below.

A transfer rule may comprise a test for source language elements to check whether a specific condition is satisfied in said linguistic structure discussed above. Such a specific condition can relate to local context or to other source language elements and their relationships in the contextual environment.

One example for local context could be an article in masculine or feminine form, which is an issue in many languages. For example, the German expression “der See” refers to the English word for “lake”, whereas the German expression “die See” refers to the English word “sea”.

An example for the contextual environment may be the English word “eat”, which is translated differently in German depending whether it refers to a human or an animal.

Specific examples for tests may be a test searching whether an adjective-compound or a noun-compound is included in said linguistic structure as described above. A further test might relate to autographic features or subject matter of the source text.

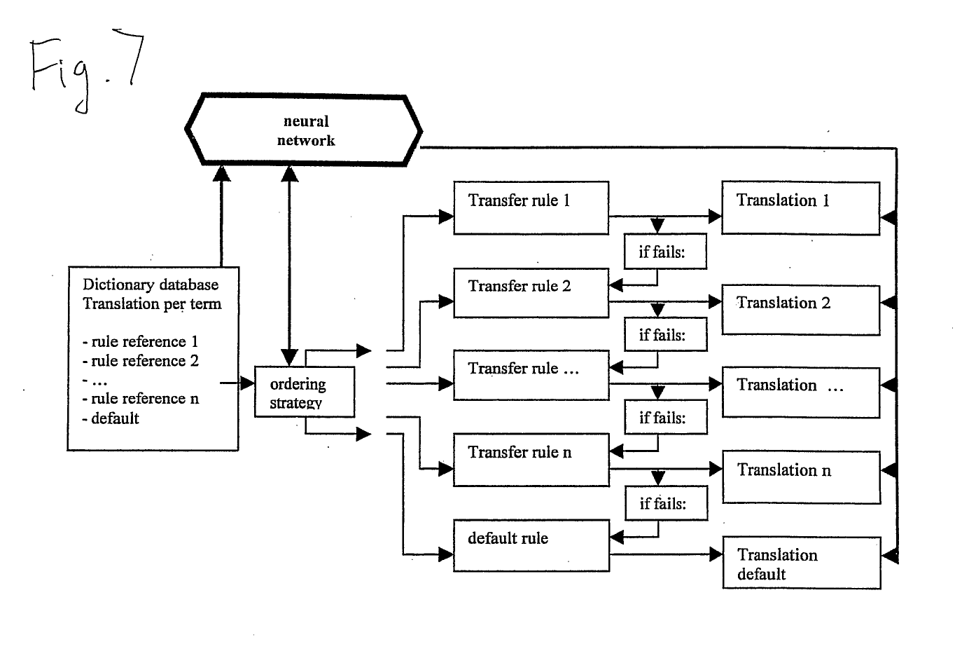

FIG. 7 shows the basic concept of a hybrid machine translation system, wherein the neural network obtains all possible source language elements and target language elements from a dictionary database. Further, the neural network influences the ordering strategy and vice versa, thereby a translation may be achieved by using a transfer rule or a neural transfer, i.e. the neural network directly.

The neural network may influence the ordering strategy up to replacing the rules altogether. By replacing the transfer rule mechanism or parts of it, the system may be made smaller as the storage of transfer rules can be released and may be made faster, since the transfer rule testing and selection process can be dropped.

Further, the neural network can also, by influencing or extending the ordering strategy, be used as a flexible device to decide, which or how many transfer rules to access and/or which transfer rules to jump over.

One mode for carrying out the invention may be described by the following embodiment using one string of source language elements as input.

This string of source language elements is input in the input unit and stored before being transferred further to said linguistic processing unit 112 and contextual processing unit 132. The linguistic processing unit then accesses the dictionary storage 100 and looks up a matching language element for a specific source language element SLE of said string.

A language element match may be of one or more language element types, containing information about whether the language element may be a verb or noun or both. This information is used in the linguistic processing unit, in which a linguistic structure, such as a syntax tree structure, is determined, and a predetermined syntax algorithm is used. From the position of the specific source language element in said syntax tree structure, it might be determined, if it is not unambiguous, whether the language element type is a verb or a noun.

This linguistic structure with source language elements and corresponding language element types is then stored in the linguistic analysis storage 114.

Meanwhile, the selecting means 118 received said string of source language elements and preferably also their corresponding language element types from said input unit 110 or linguistic processing unit 112, respectively, and selects a transfer rule from the transfer rule storage to be used for the translation of a specific source language element. The executing means 120 applies then the selected transfer rule to said stored syntax tree structure and if the condition of the selected transfer rule is fulfilled for said source language element, the source language element is converted into a target language element by looking up a language element stored in the dictionary storage, matching said source language element and corresponding to the applied transfer rule.

A similar process is performed in parallel with respect to contextual processing.

Here, said contextual processing unit 132 determines source language elements of said string, which are used as context elements. The chosen context elements, preferably all source language elements except the filler words, are then stored in the contextual text storage 134. The context executing means 136 accesses a context storage storing language elements and target language elements, wherein each language element corresponds to at least one context element predetermined in advance and said context element is linked to one target language element. The context element is another language element, which however occurs frequently in the same context as said language element previously mentioned.

Subsequently, the context executing means determines a language element of said context storage, which matches a specific source language element of said string, and which is linked with a context element stored in said context storage matching a context element of said string stored in said contextual text storage.

At this stage, the selecting means may select for said source language element previously discussed in the linguistic process, a unique target language element linked to a context element and language element stored in the context storage and defined by the determination of said context executing means or may select a unique target language element from the linguistic process, namely a transfer rule to be executed to obtain said unique target language element.

Further, the selection means determines an order, meaning whether a transfer rule is to be executed to obtain a target language element or a target language element is selected from the context storage. This order is based on weighting functions associated with the transfer rules and said target language elements stored in the context storage.

Therefore, target language elements are selected and obtained from two different processes so that the accuracy and speed of the system are improved.

In another further embodiment a computer program product directly loadable into the internal memory of a digital computer is provided, comprising software code portions for performing process steps, when said product is run on a computer. These process steps include storing in a dictionary storage 100 target language elements TLE(1), . . . , TLE(m) and language elements LE(1), . . . , LE(n) associated with predetermined language element types LET(1), . . . , LET(n), predetermined transfer rules TR(1), . . . , TR(n) and target language elements, wherein each transfer rule corresponds to one target language element TLE; determining at least one language element type LET of source language elements SLE(1), . . . , SLE(n) of a string of source language elements of said source text by searching said dictionary storage 100 for a language element LE corresponding to said source language element SLE and determining a linguistic structure of said source language elements of said string based on the determined language element types using a predetermined syntax algorithm; storing said linguistic structure determined for said string of source language elements in a linguistic analysis storage 114; storing said predetermined transfer rules in a transfer rule storage 116; selecting at least one specific transfer rule to be used with respect to a specific source language element; applying a selected transfer rule to said linguistic structure; converting a source language element SLE into a target language element by searching a language element stored in the dictionary storage 100 corresponding to said source language element SLE and by using a result of the application of said selected transfer rule; storing language elements LE(1), . . . , LE(x) and target language elements TLE(1), . . . , TLE(y) in a context storage 130, wherein each language element LE corresponds to at least one context element CE predetermined in advance and said context element corresponds to one target language element TLE, the context element comprising of at least one predetermined language element LE substantiating said target language element TLE; determining source language elements of said string which are used as context elements; storing said context elements corresponding to said source language elements in a contextual text storage 134; accessing said context storage 130 and determining a language element LE of said context storage 130 which matches a source language element SLE of said string and which is associated with a context element stored in said context storage matching a context element of said string; further selecting for a source language element SLE from said context storage a unique target language element TLE corresponding to a context element and language element based on the determination of previous step; and further determining an order of selection among transfer rules to be executed to obtain target language elements and said target language elements stored in the context storage 130 based on weighting functions associated with the transfer rules and said target language elements stored in the context storage.

In another further embodiment a computer readable medium, having a program recorded thereon is provided, wherein the program is to make the computer execute the steps: storing in a dictionary storage 100 target language elements TLE(1), . . . , TLE(m) and language elements LE(1), . . . , LE(n) associated with predetermined language element types LET(1), . . . , LET(n), predetermined transfer rules TR(1), . . . , TR(n) and target language elements, wherein each transfer rule corresponds to one target language element TLE; determining at least one language element type LET of source language elements SLE(1), . . . , SLE(n) of a string of source language elements of said source text by searching said dictionary storage 100 for a language element LE corresponding to said source language element SLE and determining a linguistic structure of said source language elements of said string based on the determined language element types using a predetermined syntax algorithm; storing said linguistic structure determined for said string of source language elements in a linguistic analysis storage 114; storing said predetermined transfer rules in a transfer rule storage 116; selecting at least one specific transfer rule to be used with respect to a specific source language element; applying a selected transfer rule to said linguistic structure; converting a source language element SLE into a target language element by searching a language element stored in the dictionary storage 100 corresponding to said source language element SLE and by using a result of the application of said selected transfer rule; storing language elements LE(1), . . . , LE(x) and target language elements TLE(1), . . . , TLE(y) in a context storage 130, wherein each language element LE corresponds to at least one context element CE predetermined in advance and said context element corresponds to one target language element TLE, the context element comprising of at least one predetermined language element LE substantiating said target language element TLE; determining source language elements of said string which are used as context elements; storing said context elements corresponding to said source language elements in a contextual text storage 134; accessing said context storage 130 and determining a language element LE of said context storage 130 which matches a source language element SLE of said string and which is associated with a context element stored in said context storage matching a context element of said string; further selecting for a source language element SLE from said context storage a unique target language element TLE corresponding to a context element and language element based on the determination of previous step; and further determining an order of selection among transfer rules to be executed to obtain target language elements and said target language elements stored in the context storage 130 based on weighting functions associated with the transfer rules and said target language elements stored in the context storage.

1. Machine translation system for converting a source text consisting of source language elements to a target text consisting of target language elements using syntax and semantics of said source language elements of said source text comprising:
an input storage containing said source text of source language elements;
a dictionary storage storing target language elements and language elements associated with predetermined language element types, predetermined transfer rules and target language elements, wherein each transfer rule corresponds to one target language element;
a linguistic processing unit determining at least one language element type of source language elements of a string of source language elements of said source text by searching said dictionary storage for a language element corresponding to said source language element and determining a linguistic structure of said source language elements of said string based on the determined language element types using a predetermined syntax algorithm;
a linguistic analysis storage for storing said linguistic structure determined for said string of source language elements;
a transfer rule storage storing said predetermined transfer rules;
selecting means for selecting at least one specific transfer rule to be used with respect to a specific source language element;
executing means for applying a selected transfer rule to said linguistic structure;
converting means for converting a source language element into a target language element by searching a language element stored in the dictionary storage corresponding to said source language element and by using a result of the application of said selected transfer rule by said executing means;
a context storage for storing language elements and target language elements, wherein each language element corresponds to at least one context element predetermined in advance and said context element corresponds to one target language element, the context element comprising at least one predetermined language element substantiating said target language element;
a contextual processing unit for determining source language elements of said string which are used as context elements;
a contextual text storage for storing said context elements corresponding to said source language elements;
context executing means for accessing said context storage and determining a language element of said context storage which matches a source language element of said string and which is associated with a context element stored in said context storage matching a context element of said string stored in said contextual text storage;
wherein said selecting means is further adapted to select for a source language element from said context storage a unique target language element corresponding to a context element and language element based on the determination by said context executing means; and
wherein said selection means is further adapted to determine an order of selection among transfer rules to be executed to obtain target language elements and said target language elements stored in the context storage based on weighting functions associated with the transfer rules and said target language elements stored in the context storage.

2. The machine translation system according to claim 1, wherein said dictionary storage is further adapted to store weights corresponding to said transfer rules.

3. The machine translation system according to claim 1, wherein said context storage is further adapted to store weights corresponding to said target language elements.

4. The machine translation system according to claim 1, wherein said weighting functions weight said transfer rules more than said target language elements stored in said context storage.

5. The machine translation system according to claim 1, wherein said weighting functions weight said transfer rules less than said target language elements stored in said context storage.

6. The machine translation system according to claim 1, wherein said weighting functions weight transfer rules relating to compound language elements highest, said target language elements stored in said context storage second to highest, transfer rules relating to specific subject matters of source texts second to lowest and defaults not associated with a transfer rule lowest.

7. The machine translation system according to claim 3, wherein said weighting functions weight transfer rules relating to compound language elements highest and target language elements stored in said context storage with large weights second to highest.

8. The machine translation system according to claim 1, wherein said order of selection among said transfer rules to be executed to obtain target language elements and said target language elements stored in said context storage is based on predetermined or dynamic weighting functions.

9. The machine translation system according to claim 8, wherein said dynamic weighting functions are determined by a neural network according to at least one of the following the size of said dictionary storage, the size of said context storage and the source text.

10. The machine translation system according to claim 1, wherein a context element comprises at least one predetermined language element obtained by a neural network and wherein each target language element is weighted according to the context element.

11. The machine translation system according to claim 1, wherein said system further comprises a text corpus analysis means for obtaining a correlation between language elements and context elements using a neural network.

12. The machine translation system according to claim 1, further comprising an output unit for outputting said selected target language elements.

13. The machine translation system according to claim 12, wherein said output unit is adapted to analyse a structure of a string of target language elements according to language element types of the target language elements.

14. The machine translation system according to claim 1, wherein said source language elements stored in said dictionary storage further comprise indices indicating an entry in the context storage.

15. The machine translation system according to claim 1, wherein said input storage is adapted to store said source text of source language elements in the form of speech or written text.

16. The machine translation system according to claim 15, wherein said system further comprises a speech-to-text unit for converting speech into text.

17. The machine translation system according to claim 1, wherein said language element types stored in said dictionary storage comprise at least one of a noun, verb, adjective, or adverb.

18. The machine translation system according to claim 1, wherein said determined linguistic structure is a syntax tree structure represented by directed acyclic graphs.

19. The machine translation system according to claim 1, wherein said syntax algorithm includes information about a position of said language element types in a string of source language elements.

20. The machine translation system according to claim 1, wherein said transfer rules stored in said transfer rule storage comprise a test for a source language element to check whether a specific condition is satisfied in said linguistic structure.

21. Machine translation method for converting a source text consisting of source language elements stored in an input storage to a target text consisting of target language elements using syntax and semantics of said source language elements of said source text comprising the steps of:
a) storing in a dictionary storage target language elements and language elements associated with predetermined language element types, predetermined transfer rules and target language elements, wherein each transfer rule corresponds to one target language element;
b) determining at least one language element type of source language elements of a string of source language elements of said source text by searching said dictionary storage for a language element corresponding to said source language element (SLE) and determining a linguistic structure of said source language elements of said string based on the determined language element types using a predetermined syntax algorithm;
c) storing said linguistic structure determined for said string of source language elements in a linguistic analysis storage;
d) storing said predetermined transfer rules in a transfer rule storage;
e) selecting at least one specific transfer rule to be used with respect to a specific source language element;
f) applying a selected transfer rule to said linguistic structure;
g) converting a source language element into a target language element by searching a language element stored in the dictionary storage corresponding to said source language element and by using a result of the application of said selected transfer rule;
h) storing language elements and target language elements in a context storage, wherein each language element corresponds to at least one context element predetermined in advance and said context element corresponds to one target language element, the context element comprising at least one predetermined language element substantiating said target language element;
i) determining source language elements of said string which are used as context elements;
j) storing said context elements corresponding to said source language elements in a contextual text storage;
k) accessing said context storage and determining a language element of said context storage which matches a source language element of said string and which is associated with a context element stored in said context storage matching a context element of said string;
l) further selecting for a source language element from said context storage a unique target language element corresponding to a context element and language element based on the determination of step k); and
m) further determining an order of selection among transfer rules to be executed to obtain target language elements and said target language elements stored in the context storage based on weighting functions associated with the transfer rules and said target language elements stored in the context storage.

22. A computer program product directly loadable into the internal memory of a digital computer, comprising software code portions for performing the steps of claim 21, when said product is run on a computer.

23. A computer readable medium, having a program recorded thereon, wherein the program is to make the computer execute the steps of claim 21.
